(19) United States
(12) Patent Application Publication
(10) Pub. No.: US 2013/0070756 A1
(43) Pub. Date: Mar. 21, 2013

(54) Method, System and Software for Establishing a Communication Channel Over a Communications Network

(71) Applicants: Roman SCHARF, Wien (AT); Daniel MATTES, Wels (AT); Karl STAGL, Guntramsdorf (AT)

(72) Inventors: Roman SCHARF, Wien (AT); Daniel MATTES, Wels (AT); Karl STAGL, Guntramsdorf (AT)

(21) Appl. No.: 13/458,096

(22) Filed: Apr. 27, 2012

Related U.S. Application Data
(63) Continuation of application No. 12/089,684, filed on Nov. 10, 2008, now abandoned.

(51) Int. Cl. H04L 29/06

(52) U.S. Cl. CPC H04L 69/16
USPC 370/352

(57) ABSTRACT

The establishment of a VoIP connection between first and second telecommunication devices (109,110) comprises receiving user input data at an input terminal remote (100) from the telecommunications devices (109,110). The input data comprises a user identifier (102) and an identifier associated with one of the telecommunications devices to be called (110). The user input data is passed to a server (103) remote from the input terminal (100). A suitable connection pathway is determined at the server (103) and a communication channel (114,115,116) is established between the devices.

This invention relates to a method, system and software for establishing a communication channel over a communications network. More particularly, but not exclusively, the invention relates to a method, system and software for establishing a voice over internet protocol (VoIP) communication channel over a communications network. Even more particularly, but not exclusively, the invention relates to a method, system and software for establishing a VoIP communication channel over a communications network in which a call initiating terminal does not have VoIP client software running thereupon.

VoIP is a method of carrying voice data via a network using the internet protocol (IP) of data transfer. VoIP involves the transmission of digitised packets of voice information via a data network rather than using a point-to-point committed telephone channel such as those employed by both analogue and digital public switched telephone networks (PSTNs). An acknowledged standard for such VoIP data transfer is ITU-T H.323.

VoIP has a number of problems associated with it's implementation including latency due to routeing patterns and delays associated with transmission channels, for example delays associated with calls routed via satellite. The use of high bandwidth channels allows low latency, high quality VoIP channels. Private networks offer the high bandwidths required, however general public access networks, for example 256 kb dial up connections, do not offer sufficiently high bandwidths to prevent latency effects.

However, it is difficult to ensure a high quality of service (QoS) with public networks and therefore a private network operated by an Internet telephone service provider (ITSP) is often used by consumers.

Attempts have been made to ensure the delivery of packets to a destination terminal in an ordered manner by the use of the real time protocol (RTP). This increases the likelihood of proper packet ordering.

One problem associated with VoIP that has not been addressed is the interfacing of legacy, non-VoIP, terminal with VoIP telephony systems. The installation of VoIP software onto such a legacy terminal may be impractical or expensive.

According to a first aspect of the present invention there is provided a method of establishing a VoIP connection between first and second telecommunication terminals comprising the steps of:
i) receiving user input data, comprising both a user identifier and an identifier associated with the second telecommunications terminal, at an input terminal remote from both the first and second telecommunication terminals;
ii) passing said user input data to a server remote from the input terminal;
iii) determining a suitable connection pathway at the server; and
iv) establishing a communication channel between the first and second telecommunication terminals.

The present invention provides a method and system for establishing a call between two endpoints using VoIP without the necessarity of installing additional VoIP specific Hard- or Software. This system of the present invention allows a user to establish a VoIP based call between two endpoints without having a) a VoIP specific Software application or b) a VoIP enabled Hardware device. These calls can be established between a) mobile/landline phone to mobile/landline phone, b) mobile/landline phone to Internet based phone, c) Internet based phone to mobile/landline phone or d) Internet based phone to Internet based phone.

The communication channel established in step (v) may comprise a VoIP communication channel. The first telecommunication terminal may comprise software excluding VoIP client software. Alternatively, the first telecommunication terminal may comprise VoIP client software which is disabled.

Such a system allows the establishment of VoIP connections between, for example, a legacy mobile telephone that cannot be retrofitted to operate VoIP software and any other terminal.

The first, and/or the second telecommunication terminal, may comprise any one of the following: personal digital assistant (PDA), mobile telephone, personal computer (PC).

The user input terminal may comprise a PC.

The user input data may comprise a telephone number, or an Internet address. Alternatively, or additionally, the user input data may comprise a name corresponding to a user of the second telecommunications terminal.

The user input data may comprise an identifier that identifies a specific user, the server may be arranged to be directed to a specified entry, or group of entries in the data structure in response to analysing the identifier.

The method may comprise outputting a cost of the communications channel at the first telecommunications terminal.

According to a second aspect of the present invention there is provided a data structure comprising a plurality of address data entries corresponding network addresses, the data structure being accessible by a processor such that selective interrogation of the data structure releases data corresponding to a network address to the processor for the establishment of a communications channel between a terminal corresponding to the network address and a further terminal.

The data structure may comprise identifier data entries. The address data entries may be grouped according to at least one identifier data entry associated therewith.

According to a third aspect of the present invention there is provided software which when run on a processor causes the processor to establish a communications channel between the first and second telecommunications terminals of the first aspect of the present invention in accordance with at least steps (iii) to (v) of the first aspect of the present invention.

According to a fourth aspect of the present there is provided a server arranged to execute, at least steps (iii) to (v) of the first aspect of the present invention.

The server may comprise a data structure according to the second aspect of the present invention.

According to a fifth aspect of the present invention there is provided a method of reducing the cost of telecommunications between a first telecommunications device comprising either software excluding VoIP client software or VoIP client software which is disabled and a second telecommunications terminal comprising the method according to the first aspect of the present invention.

According to a sixth aspect of the present invention there is provided a method of establishing a call between two endpoints comprising:
(i) under control of a client system, selecting a source endpoint; selecting a destination endpoint;
(ii) in response to a single action being performed, sending these information's to the server system; u
(iii) under control of a server system, calling the source endpoint; waiting for pick up;
(iv) playing a notification message;
(v) calling the destination endpoint;
(vi) waiting for pick up;
(vii) connecting source and destination endpoints together.

The selection of the source endpoint may be done by manual input from the user in his client system. The selection of the source endpoint may be done by choosing one of provided pre-entered data. The selection of the destination endpoint may be done by manual input from the user in his client system. The selection of the destination endpoint may be done by choosing one of provided pre-entered data. The server system may provide information about the costs per minute for the call. The single action may comprise clicking a button. The single action may comprise speaking of sound. The client systems display component may comprise a browser. The client systems display component may comprise a mobile phone. The source endpoint may comprise a landline or mobile phone (PSTN). The source endpoint may comprise a VoIP based Software application or Software module. The source endpoint may comprise a VoIP enabled Hardware device. The destination endpoint may comprise a VoIP based Software application or Software module. The destination endpoint may comprise a VoIP enabled Hardware device

According to a seventh aspect of the present invention there is provided a method of establishing a call between two endpoints comprising:
(i) under control of a client system, selecting a source endpoint;
(ii) selecting a destination endpoint;
(iii) in response to a single action being performed, sending this information to the server system;
(iv) under control of a server system, calling the source endpoint;
(v) waiting for pick up;
(vi) calling the destination endpoint; waiting for pick up; and
(vii) connecting source and destination endpoints together.

The selection of the source endpoint may be done by manual input from the user in his client system. The selection of the source endpoint may be done by choosing one of provided pre-entered data. The selection of the destination endpoint may be done by manual input from the user in his client system. The selection of the destination endpoint may be done by choosing one of provided pre-entered data. The server system may provide information about the costs per minute for the call. The single action may comprise clicking a button. The single action may comprise speaking of sound. The client systems display component may comprise a browser. The client systems display component may comprise a mobile phone. The source endpoint may comprise a landline or mobile phone (PSTN). The source endpoint may comprise a VoIP based Software application or Software module. The source endpoint may comprise a VoIP enabled Hardware device. The destination endpoint may comprise a VoIP based Software application or Software module. The destination endpoint may comprise a VoIP enabled Hardware device

The invention will now be described, by way of example only, with reference to the accompanying drawings, in which:

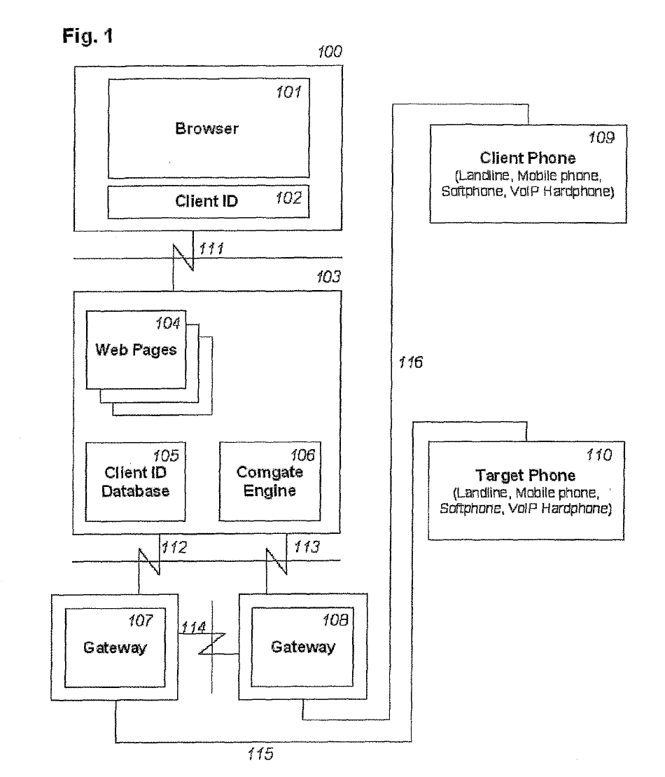

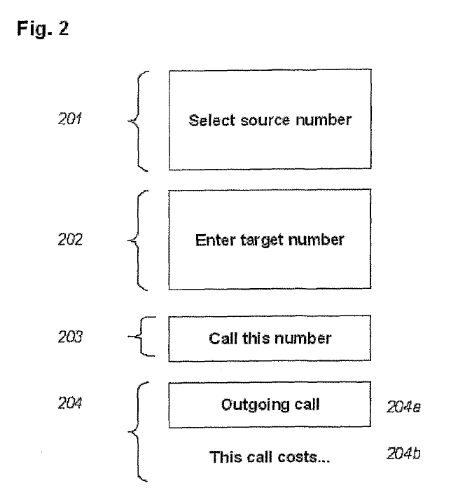

FIG. 1 is a block diagram illustrating an embodiment of a VoIP telephony system employing an embodiment of a method of call establishment according to at least one aspect of the present invention;

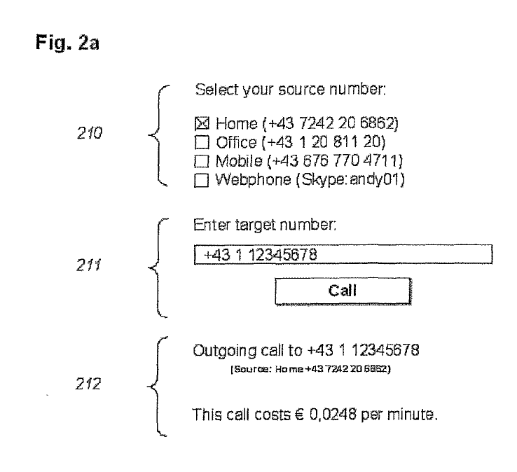

FIG. 2 and FIG. 2a illustrate an embodiment of a method of call establishment according to at least one aspect of the present invention;

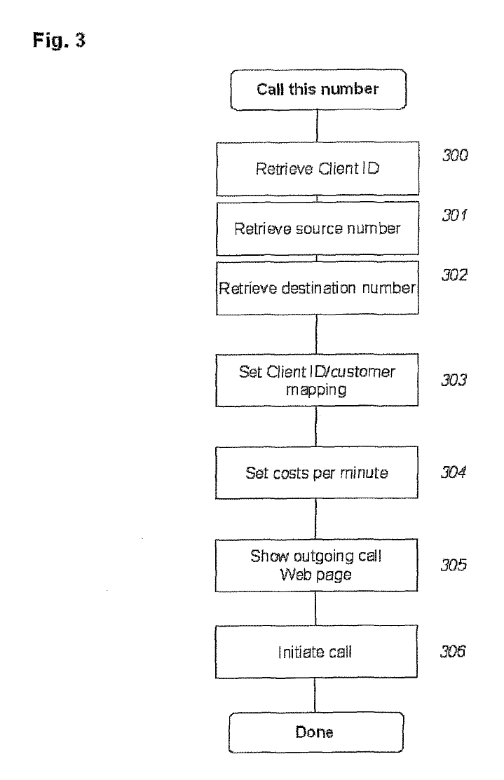

FIG. 3 is a flow diagram of a routine to establish the calls, the routine comprising an aspect of the method of FIG. 2; and

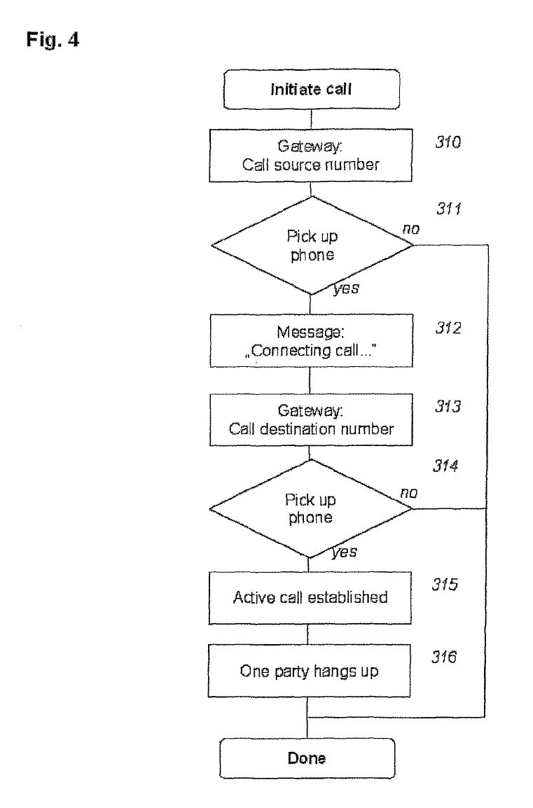

FIG. 4 is a flow diagram of a routine to establish the calls on the gateway, the routine comprising an aspect of the method of FIG. 2.

Referring now to FIG. 1 a telephony system comprises a client computer system (100) in communication (111) with a server (103) via a data transfer network, typically the Internet, gateways (107,108), a client telephone (109) and a target telephone (110).

The client computer system has a unique Client ID (102) stored upon it that identifies the user of the system (100). The client system (100) provides a unique Client ID and the two numbers to connect (source number and destination number) to the server (103). These endpoints can be usual mobile or landline phones (PSTN) or any VoIP based Software application or VoIP based Hardware device.

A user of the client computer system accesses Web pages (104) stored at the server (103) via a web browser (101), for example MS Internet Explorer. The web pages (104) store text and graphical elements to the client computer system.

A client ID database (105) is stored at the server (103). The client ID database (105) retains user relevant data for example, defined source, telephone, numbers. The client ID database (105) is accessed and the client ID data (102) checked when a user accesses the server (103) via the web browser (101). Frequently dialled numbers associated with the user can be recalled from the client (ID) database (105) and displayed in an address book within the web browser (101).

Communication with the gateways (107, 108) is established via the communications Engine (106) over a network (112, 113), typically the Internet. These gateways (107,108) communicate via a network (115, 116), typically the Internet, using IP protocols to establish a voice connection. If the endpoint is a VoIP based Software Telephone, or a VoIP enabled Hardware device, the gateways communicate direct with the client and target telephones (109, 110). Alternatively, if the endpoint is a mobile or landline PSTN phone the gateways communicate with the client and target telephones (109, 110) over a PSTN Gateway.

Referring now to FIGS. 2 to 4, a user selects the endpoint where he wants to place the call from (“source number”) on a client computer system (e.g. via Web page) 201.

Numerous predefined options (subsection 210) are presented to the user. These options derive from the server computer system, depending on the provided unique Client ID, which are stored in the server's Client ID Database. The customer identifier can be stored at the client system so that the customer does not need to re-enter his customer identifier each time access is initiated.

Typical, options comprise an address book, or call restrictions based either on price of call or location. Thus, a user can be prevented from accessing premium rate phone lines.

The user enters the number of the target endpoint to call (“target number”) 202 (subsection 211).

In order to establish the call an action is taken, for example, clicking a mouse on button labelled “Call”. This action causes the client computer system to send the data to the server computer system (203).

The server computer system retrieves client ID (300), source number (301) and destination number (302). The server computer system maps Client ID to validate the customer from the client ID (303) and calculates the per-minute costs for this call (304).

The client computer system will retrieve this data via a network, typically the Internet, and displays the call costs via a Web browser (204b) along with the source and destination numbers (204a).

The server computer system initiates the telephone call (306). The Server computer system determines a suitable, typically the optimal, gateway accessible to the source number and causes the gateway to establish a connection to the source number (310).

When the called, source, party picks up the phone (311) the gateway plays back a notification message (312). If not, the process will be stopped.

Subsequent to the acceptance of the source call by the source party, the server computer system initiates the call to the destination number (313), in a similar manner to that referred to in regard of the source.

During the establishment of a connection to the destination number a ringtone is played in the source party's device.

When the called, destination, party picks up (314) their device and accepts the call, the server computer system will connect both calls together (315). Thus a communication channel is established between the source and destination parties.

If the destination party will not pick up the call, the process is terminated.

After at least one party hangs up the established call (316) the process is terminated.

Voice data streams are transmitted between the two gateways over the network, typically the Internet, using for example IP protocols in order to establish a VoIP data channel.

Where one party has a VoIP Software Telephone or VoIP enabled Hardware device, the voice data streams are transmitted from the Gateway to this party directly over the network, typically the Internet.

Where one party is using a landline or mobile phone device (PSTN), the voice streams are transmitted from the gateway to an PSTN gateway.

Although the present invention has been described in terms of various embodiments, it is not intended that the invention be limited to these embodiments. Modification within the spirit of the invention will be apparent to those skilled in the art. For example, the server system can map a client identifier to multiple customers who have recently used the client system. The server system can then allow the user to identify themselves by selecting one of the mappings based preferably customer specific source numbers.

Various different single actions can be used to effect the establishment of a call. For example, a voice command may be spoken by the user, a key may be depressed by the user, a button on a television remote control device may be depressed by the user, or selection using any pointing device may be effected by the user.

It will be appreciated that although a single action may be proceeded by multiple movements of the customer (e.g. moving a mouse so that a mouse pointer is over a button), the single action generally refers to a single event received by a client system that indicates to establish a call.

It will be further appreciated that the customer may be identified by a unique customer identifier that is provided by the customer when the customer initiates access to the server system and sent to the server system with each message.

1. A method of establishing a VoIP connection between first and second telecommunication terminals comprises the steps of:
i) receiving user input data, comprising both a user identifier and an identifier associated with the second telecommunications terminal, at an input terminal remote from both the first and second telecommunication terminals;
ii) passing said user input data to a server remote from the input terminal;
iii) determining a suitable connection pathway at the server; and
iv) establishing a communication channel between the first and second telecommunication terminals.

2.-32. (canceled)
